(19) United States
(12) Patent Application Publication
(10) Pub. No.: US 2003/0037271 A1
(43) Pub. Date: Feb. 20, 2003

(54) Reducing clock skew by power supply isolation

(76) Inventors: Dean Liu, Sunnyvale, CA (US); Tyler J. Thorp, Sunnyvale, CA (US); Pradeep R. Trivedi, Sunnyvale, CA (US); Gin S. Yee, Sunnyvale, CA (US)

Correspondence Address: JONATHAN P. OSHA, ROSENTHAL & OSHA LLP, 1221 MCKINNEY STREET, SUITE 2800, HOUSTON, TX, 77010, US

(21) Appl. No.: 09/930,076

(22) Filed: Aug. 15, 2001

(51) Int. Cl. G06F 1/26

(52) U.S. Cl. 713/322

(57) ABSTRACT

A method and apparatus for reducing clock skew by isolating power distribution to a clock tree from chip logic is provided. Further, the present invention uses separate leads through a circuit board to distribute power from a power supply to a clock tree and a chip logic.

### BACKGROUND OF INVENTION

As computers operate at increasing clock speeds, it becomes critical to ensure that clock signals on a computer chip are provided to various logic elements on the computer chip in an accurate and timely manner. However, due to one or more types of variations across the computer chip, a particular clock signal may arrive at different parts of the chip at different times. This difference in the arrival of a clock signal at different logic elements is referred to as “skew.”

One of the variations that leads to clock skew is voltage variation across the chip. This voltage variation may be caused by the fact that a clock tree, which includes one or more clock drivers (also known in the art as “clock buffers”), and chip logic use the same power supply. When particular logic elements on the computer chip need some amount of power, current is drawn from the power supply/decoupling capacitors, and because the logic elements are sharing the same power supply, the voltage at the clock drivers decreases. Moreover, because the clock drivers have to operate at lower voltage, the clock drivers generate clock signals with poor edge rates, which, in turn, causes changes in the delays of the clock drivers, effectively leading to clock skew on the computer chip.

FIG. 1 shows a part of a typical computer chip including segments of a clock tree (10) and chip logic (12). The clock tree (10) has a clock generator (14), a first clock driver (16), a second clock driver (18), and a last clock driver (20). The clock tree (10) and chip logic (12) receive power from a power supply (22). Further, a decoupling capacitor (24) is provided/used to reduce voltage variation of the power supply (22).

In the event that the chip logic (12) needs current, current from the decoupling capacitor (24) is steered away to the chip logic (12). Because one or more of the clock drivers are now operating at a lower voltage, these clock drivers generate clock signals that are not as sharp as when the clock drivers were operating at normal voltage levels. This results in adverse delay effects on the clock signals which lead to clock skew. For example, FIG. 2 shows the effect of lower voltage on a resulting clock signal generated by a clock driver. Specifically, FIG. 2 shows the voltage variation (30) that occurs on the clock tree (10) as the chip logic (12) requires additional power. FIG. 2 also shows an expected clock signal (32) and an actual clock signal (34).

The voltage variation (30) shown is between 1.0 volts and 1.2 volts. At normal levels, the clock tree (10) operates at 1.2 volts. In cases where the chip logic (12) is drawing current from the decoupling capacitor (24), the clock tree (10) operates at 1.0 volts. The expected clock signal (32) shows the waveform that results when the clock tree (10) continuously operates at 1.2 volts. The actual clock signal (34) shows the waveform that results when the clock tree (12) oscillates between 1.0 volts and 1.2 volts. From the actual clock signal (34), it is evident that when the clock tree (10) operates at 1.0 volts, the edge quality of the pulses of the actual clock signal (34) become less sharp relative to that of the pulses of the expected clock signal (32). This results in changes of the delays of one or more clock drivers (16, 18, 20). Further, these deteriorated edges of the actual clock signal (34) may propagate while being sent to parts of the computer chip, effectively increasing clock skew.

### SUMMARY OF INVENTION

According to one aspect of the present invention, a computer chip comprising a power supply comprises chip logic and a clock tree that comprises at least one clock driver, where power distributed from the power supply to the clock tree is isolated from power distributed from the power supply to the chip logic.

According to another aspect, a method for reducing clock skew comprises drawing current from a power supply for chip logic operations, and drawing current from the power supply for clock tree operations, where the current drawn from the power supply for the chip logic operations is isolated from the current drawn from the power supply for the clock tree operations.

Other aspects and advantages of the invention will be apparent from the following description and the appended claims.

### BRIEF DESCRIPTION OF DRAWINGS

FIG. 1 shows part of a typical computer chip having a clock tree and chip logic.

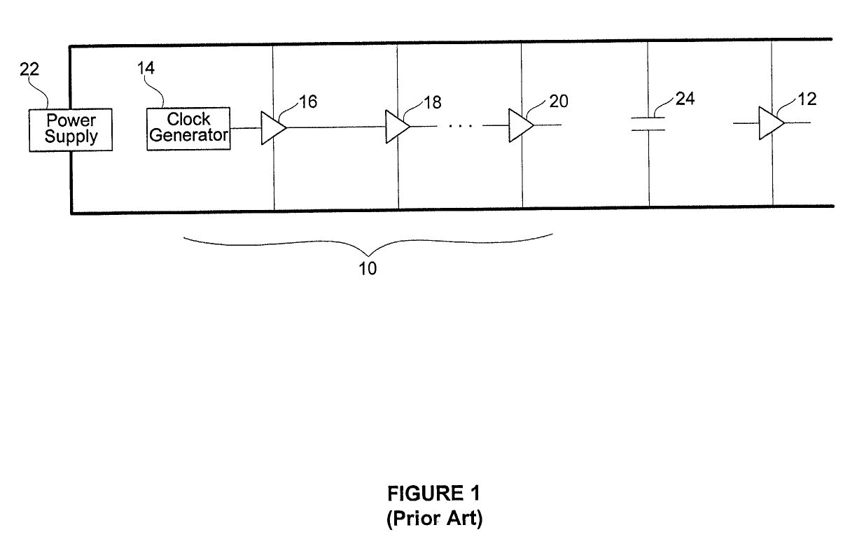

FIG. 2 shows a voltage variation that occurs in a typical computer chip.

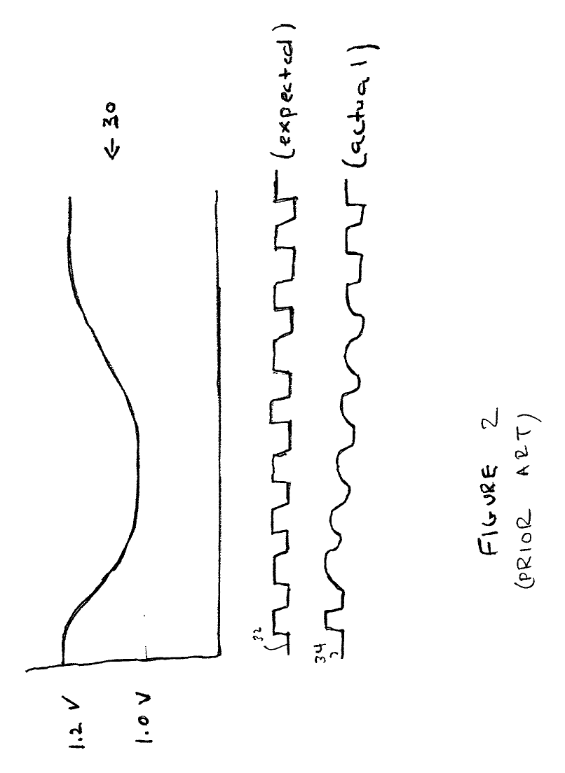

FIG. 3 shows a part of a computer chip having a clock tree and chip logic in accordance with an embodiment of the present invention.

FIG. 4 shows a computer chip having a clock tree and chip logic in accordance with an embodiment of the present invention.

### DETAILED DESCRIPTION

The present invention relates to a method and apparatus for reducing clock skew by isolating a power supply between a clock tree and chip logic. The present invention further relates to a method and apparatus for reducing noise on a chip by isolating a power supply between a clock tree and chip logic.

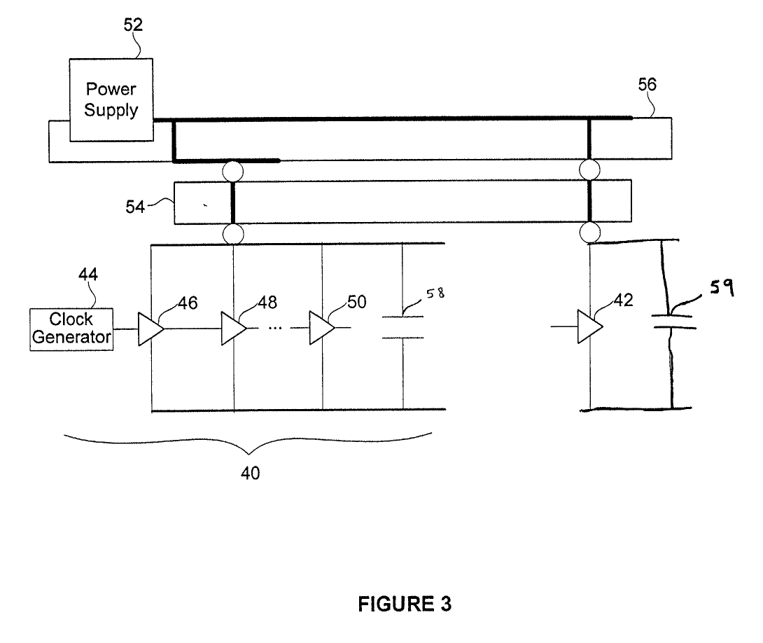

FIG. 3 shows a part of a computer chip including segments of a clock tree (40) and chip logic (42) in accordance with an exemplary embodiment of the present invention. The clock tree (40) has a clock generator (44), a first clock driver (46), a second clock driver (48), and a last clock driver (50). The clock tree (40) receives power from a power supply (52) via a connection through a chip package (54) and circuit board (56). The chip logic (42) receives power from the power supply (52) via a separate connection through the chip package (54) and circuit board (56). As FIG. 3 shows, the power distribution to the clock tree (40) and chip logic (44) are isolated at the circuit board (56). Further, capacitors (58, 59) are provided to decouple noise generated by the power supply (52).

Those skilled in the art will appreciate that when the chip logic (42) of the computer chip needs additional amounts of power, current is drawn from the power supply (52) without affecting the power delivered from the power supply (52) to the clock tree (40). Further, those skilled in the art will appreciate that in other embodiments, the power supply may be on the computer chip instead of the circuit board.

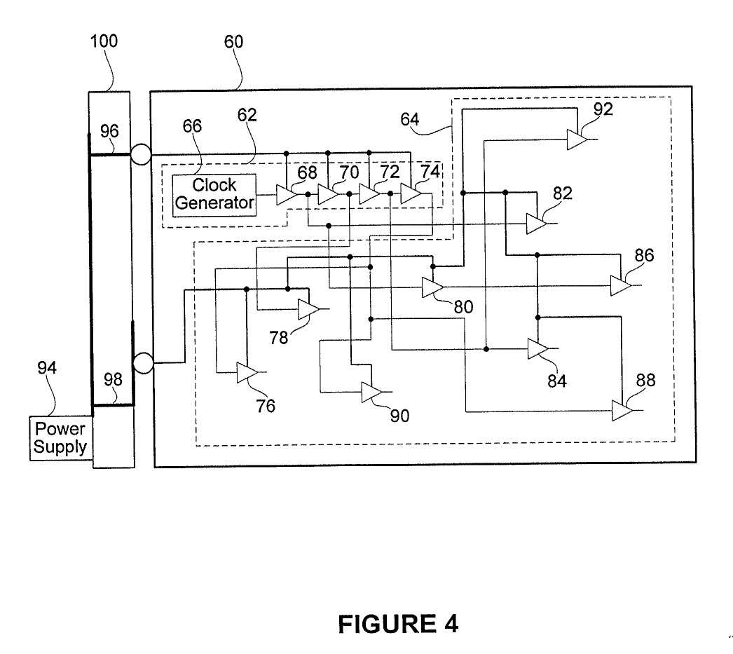

FIG. 4 shows a computer chip (60) having a clock tree (62) and chip logic (64) in accordance with an exemplary embodiment of the present invention. The clock tree (62) has a clock generator (66) and a plurality of clock drivers (68, 70, 72, 74). The chip logic (64) has a plurality of logic elements (76, 78, 80, 82, 84, 86, 88, 90, 92). Power from a power supply (94) is distributed to the clock tree (62) and chip logic (64) via separate leads (96, 98) through a chip package (100).

Those skilled in the art will appreciate that in other embodiments, the separate leads may be through a circuit board. Those skilled in the art will also appreciate in other embodiments, the clock tree may have only one clock driver. Further, those skilled in the art will appreciate that the chip logic may have zero or only one logic element.

Advantages of the present invention may include one or more of the following. In some embodiments, because power distributed a clock tree is isolated from power distributed to chip logic, clock skew is reduced.

In some embodiments, because power distributed to a clock tree is isolated from power distributed to chip logic, noise generated by a power supply is reduced due to less current draw away from a capacitor used to decouple noise from the power supply.

In some embodiments, because a clock tree generates a clock signal having a sharper edge rate relative to a clock signal generated by the clock tree at a lower voltage, chip logic dependent on the clock signal operates more quickly and accurately.

In some embodiments, because a clock tree generates a clock signal having a sharper edge rate relative to a clock signal generated by the clock tree at a lower voltage, performance is increased, and a computer chip may thus be operated at higher frequencies.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer chip comprising a power supply, comprising:
chip logic; and
a clock tree that comprises at least one clock driver, wherein power distributed from the power supply to the clock tree is isolated from power distributed from the power supply to the chip logic.

2. The computer chip of claim 1, further comprising:
a capacitor, wherein power distributed from the power supply to the capacitor is isolated from power distributed from the power supply to the chip logic.

3. The computer chip of claim 1, wherein the chip logic comprises at least one logic element.

4. The computer chip of claim 1, wherein the clock tree comprises at least one clock driver.

5. The computer chip of claim 1, further comprising:
a first lead through a circuit board to the computer chip, wherein the first lead is used to distribute power from the power supply to the clock tree; and
a second lead through the circuit board to the computer chip, wherein the second lead is used to distribute power from the power supply to the chip logic.

6. The computer chip of claim 5, wherein the first lead runs through a chip package, and wherein the second lead runs through the chip package.

7. A method for reducing clock skew, comprising:
drawing current from a power supply for chip logic operations; and
drawing current from the power supply for clock tree operations, wherein the current drawn from the power supply for the chip logic operations is isolated from the current drawn from the power supply for the clock tree operations.

8. The method of claim 7, wherein the clock tree comprises a clock generator and at least one clock driver.

9. The method of claim 7, wherein the chip logic comprises at least one logic element.

10. The method of claim 7, further comprising:
drawing current from the power supply to decouple noise, wherein the current drawn from the power supply to decouple noise is isolated from the current drawn for the chip logic operations.

11. The method of claim 7, further comprising:
using separate leads through a chip package to distribute power from the power supply to the clock tree and the chip logic.

12. The method of claim 7, further comprising:
using separate leads through a circuit board to distribute power from the power supply to the clock tree and the chip logic.
